(19) United States
(12) Patent Application Publication
(10) Pub. No.: US 2023/0031481 A1
(43) Pub. Date: Feb. 2, 2023

(54) OPTICAL SORTING DEVICE

(71) Applicant: SATAKE CORPORATION, Chiyoda-ku, Tokyo (JP)

(72) Inventor: Yoichi KAWAMURA, Chiyoda-ku, Tokyo (JP)

(73) Assignee: SATAKE CORPORATION, Chiyoda-ku, Tokyo (JP)

(21) Appl. No.: 17/788,550

(22) PCT Filed: Dec. 9, 2020
(86) PCT No.: PCT/JP2020/045894

§ 371 Date: Jun. 23, 2022

(30) Foreign Application Priority Data
Dec. 24, 2019 (JP) 2019-233200
Dec. 24, 2019 (JP) 2019-233205

(51) Int. Cl. B07C 5/342; B07C 5/36

(52) U.S. Cl. CPC B07C 5/3425; B07C 5/366

(57) ABSTRACT

Provided is an optical sorting device including a chute having an optical detection slit and a sorting and removal slit arranged on a downstream side of the optical detection slit, an object to be sorted flowing down on a front surface of the chute. A rear-side illuminating portion of an optical inspection unit and an ejector nozzle are attached to a rear-side housing. The rear-side housing is installed on a rear surface side of the chute such that the rear-side illuminating portion faces the optical detection slit, and a leading end of the ejector nozzle faces the sorting and removal slit.

### TECHNICAL FIELD

The present invention relates to an optical sorting device that sorts grains such as cereal grains, beans, or resin pellets based on the color or the like.

### BACKGROUND ART

Grains such as cereal grains, beans, or resin pellets may be sorted into non-defective grains and defective grains based on the color or the like to remove the defective grains, or mixed foreign matters are removed in some cases.

For example, Patent Literature 1 discloses an optical grain sorting device in which an optical detecting unit is provided below a chute along which cereal grains flow down, a falling trajectory of grains flowing down from the chute being interposed between the chute and the optical detecting unit, an ejector nozzle is provided further below the optical detecting unit, and the optical detecting unit detects whether a falling-down grain is a non-defective grain or a defective grain, and a grain determined as a defective grain is removed from flowing-down grains with high-pressure ejected air ejected from the ejector nozzle.

The optical grain sorting device as described in Patent Literature 1 above removes a defective grain fallen down from the chute with ejected air. However, some grains do not fall down along a constant flying trajectory due to turbulence of the flying attitude in the air, and thus, ejected air may not hit a defective grain to cause a sorting mistake.

In order to improve sorting performance, the Applicant has filed Patent Literature 2. This is a device in which a chute of a sorting unit is provided with an optical detection slit and a sorting and removal slit.

### CITATION LIST

### Patent Literature

[Patent Literature 1] Japanese Patent Laid-Open No. 2014-157119
[Patent Literature 2] Japanese Patent Application No. 2019-209821

### SUMMARY OF INVENTION

### Technical Problem

The optical sorting device as in Patent Literature 2 requires an optical detecting unit to be provided in correspondence to the optical detection slit of the chute, and an ejector nozzle to be provided in correspondence to the sorting and removal slit further below the optical detection slit. This results in size increase as a whole, burdensome assembling, and unsuitableness to manual or robot mass production. In particular, in such a case of attaching the device to a rice husking machine, such problems are pronounced.

In addition, it is required to minimize the distance between the optical detection slit and the sorting and removal slit, achieve size reduction, and improve sorting accuracy.

Furthermore, in the optical sorting device as in Patent Literature 2, the optical detection slit on the chute is formed. Thus, dust and the like including dust and powder particles produced by flowing-down grains could enter the rear surface side of the chute through the optical detection slit, and adhere to equipment installed on the rear surface side of the chute to cause adverse effects. In particular, in such a case of attaching the device to a rice husking machine, optical equipment is likely to degrade significantly in performance due to adhesion of dust and the like, and a sorting mistake is likely to occur.

In addition, fitting a translucent plate in the optical detection slit to prevent dust and the like from entering is also conceivable. However, when dust and the like adhere to the translucent plate, translucency may degrade. Furthermore, when trying to remove dust and the like adhering to the translucent plate, it is necessary to stop flow-down of grains so as to operate removing means on the front surface side of the chute, which interrupts a sorting operation.

An objective to be achieved by the present invention is to provide an optical sorting device which is compact, easy to assemble, and suited to mass production. An objective to be achieved by the present invention is to provide an optical sorting device which minimizes the distance between the optical detection slit and the sorting and removal slit, has high sorting accuracy, and is compact. In addition, an objective to be achieved by the present invention is to provide an optical sorting device which prevents dust and the like produced on the front surface side of the chute from entering the rear surface side through the optical detection slit without providing the optical detection slit with a translucent plate, so that a sorting mistake is less likely to occur.

### Solution to Problem

An invention according to claim 1 of the present application is an optical sorting device including: a chute having an optical detection slit and a sorting and removal slit arranged on a downstream side of the optical detection slit, an object to be sorted flowing down on a front surface of the chute; an optical inspection unit having an illuminating part having a rear-side illuminating portion installed on a rear surface side of the chute and configured to emit light to the object to be sorted through an opening, a light receiving part configured to receive at least one of transmitted light and reflected light from the object to be sorted of the light emitted from the illuminating part, and an optical path configured to send at least one of the transmitted light and the reflected light to the light receiving part, the optical inspection unit being configured to inspect the object to be sorted flowing down on the front surface of the chute; and an ejector unit having an ejector nozzle capable of ejecting air to the object to be sorted flowing down on the front surface of the chute, and configured to sort and remove the object to be sorted based on an inspection result obtained by the optical inspection unit. The optical sorting device includes a base member attached to the rear surface side of the chute. At least the rear-side illuminating portion and the ejector nozzle are attached to the base member, and the base member is installed such that the opening of the rear-side illuminating portion faces the optical detection slit, and a leading end of the ejector nozzle faces the sorting and removal slit.

An invention according to claim 2 of the present application is the optical sorting device according to claim 1, in which the base member or the rear-side illuminating portion includes a positioning protrusion to be inserted into the optical detection slit to position the base member on the chute.

An invention according to claim 3 of the present application is the optical sorting device according to claim 1 or 2, in which the base member or the ejector nozzle includes a positioning protrusion to be inserted into the sorting and removal slit to position the base member on the chute.

An invention according to claim 4 of the present application is the optical sorting device according to any one of claims 1 to 3, in which the base member is a rear-side housing, the ejector unit has the ejector nozzle, a manifold configured to distribute high-pressure air to the ejector nozzle, and an electromagnetic valve configured to control distribution of the manifold based on the inspection result obtained by the optical inspection unit, the rear-side illuminating portion, the ejector nozzle, and the manifold are stored in the rear-side housing, and the electromagnetic valve is attached to an outer surface of the rear-side housing.

An invention according to claim 5 of the present application is the optical sorting device according to claim 4, in which a projecting piece is extended at the outer surface of the rear-side housing, the electromagnetic valve is provided with an engaging stop, and the engaging stop is brought into snap engagement with the projecting piece to attach the electromagnetic valve to the outer surface of the rear-side housing.

An invention according to claim 6 of the present application is the optical sorting device according to any one of claims 1 to 3, in which the base member is a rear-side housing, the ejector unit has the ejector nozzle, a manifold configured to distribute high-pressure air to the ejector nozzle, and an electromagnetic valve configured to control distribution of the manifold based on the inspection result obtained by the optical inspection unit, the rear-side illuminating portion and the ejector nozzle are stored in the rear-side housing, and the ejector nozzle is coupled to the manifold and the electromagnetic valve installed outside the rear-side housing with an air hose.

An invention according to claim 7 of the present application is the optical sorting device according to any one of claims 1 to 6, in which the rear-side illuminating portion has a light source, and a reflector configured to reflect light radiated from the light source toward the optical detection slit, and the light source, the reflector, and the ejector nozzle are arranged in an order presented from an upstream side of the chute.

An invention according to claim 8 of the present application is the optical sorting device according to any one of claims 1 to 7, including a front-side housing on a front surface side of the chute, in which the illuminating part has a front-side illuminating portion installed on the front surface side of the chute, and at least the front-side illuminating portion, the light receiving part, and the optical path are stored in the front-side housing.

An invention according to claim 9 of the present application is a rice husking and sorting machine including the optical sorting device according to any one of claims 1 to 8.

An invention according to claim 10 of the present application is an optical sorting device including: a chute having an optical detection slit, an object to be sorted flowing down on a front surface of the chute; an optical inspection unit having a rear-side optical inspection part having an illuminating portion configured to emit light toward the optical detection slit and a light receiving portion configured to receive at least one of transmitted light and reflected light of the light emitted from the illuminating portion, at least one of the illuminating portion and the light receiving portion being arranged on a rear surface side of the chute, the optical inspection unit being configured to inspect the object to be sorted flowing down on the front surface of the chute; and an ejector unit configured to sort and remove the object to be sorted based on an inspection result obtained by the optical inspection unit, in which a slit air nozzle capable of forming an air curtain configured to prevent dust and the like from entering the rear-side optical inspection part through the optical detection slit is provided on the rear surface side of the chute.

An invention according to claim 11 of the present application is the optical sorting device according to claim 10, in which the slit air nozzle is arranged such that air of the air curtain is ejected from an upstream side to a downstream side of the chute.

An invention according to claim 12 of the present application is the optical sorting device according to claim 11, in which the ejector unit has an ejector nozzle capable of ejecting air to the object to be sorted on a downstream side of the optical detection slit, an air discharge part is provided on a downstream side of the air curtain ejected from the slit air nozzle, and a surface of the air discharge part opposite to the slit air nozzle is inclined to the downstream side with distance from the optical detection slit.

An invention according to claim 13 of the present application is the optical sorting device according to any one of claims 10 to 12, in which the rear-side optical inspection part includes a rear translucent plate configured to block circulation of air between the slit air nozzle and at least one of the illuminating portion and the light receiving portion that the rear-side optical inspection part has.

An invention according to claim 14 of the present application is the optical sorting device according to claim 13, in which a rear translucent plate air nozzle capable of forming an air curtain configured to prevent dust and the like from adhering to the rear translucent plate is provided on a side of the slit air nozzle of the rear translucent plate.

An invention according to claim 15 of the present application is the optical sorting device according to claim 12, in which the rear-side optical inspection part includes a rear translucent plate configured to block circulation of air between the slit air nozzle and at least one of the illuminating portion and the light receiving portion that the rear-side optical inspection part has, a rear translucent plate air nozzle capable of forming an air curtain configured to prevent dust and the like from adhering to the rear translucent plate is provided on a side of the slit air nozzle of the rear translucent plate, an air discharge part is provided on a downstream side of the air curtain ejected from the rear translucent plate air nozzle, and the air discharge part also discharges the air curtain ejected from the slit air nozzle.

An invention according to claim 16 of the present application is the optical sorting device according to any one of claims 10 to 15, in which the optical inspection unit has a front-side optical inspection part having an illuminating portion configured to emit light toward the optical detection slit and a light receiving portion configured to receive at least one of transmitted light and reflected light from the sorting unit of the light emitted from the illuminating portion, at least one of the illuminating portion and the light receiving portion being arranged on a front surface side of the chute, the front-side optical inspection part includes a front translucent plate configured to block circulation of air between the chute and at least one of the illuminating portion and the light receiving portion that the front-side optical inspection part has, and a front translucent plate air nozzle capable of forming an air curtain configured to prevent dust and the like from adhering to the front translucent plate is provided for the front translucent plate on a side of the chute.

An invention according to claim 17 of the present application is the optical sorting device according to claim 16, in which the front translucent plate air nozzle is arranged such that the air curtain formed is ejected so as to be gradually depart from the flowing down direction of the object to be sorted.

An invention according to claim 18 of the present application is a rice husking and sorting machine including the optical sorting device according to any one of claims 10 to 17.

### Advantageous Effects of Invention

Since the present invention blows air to an object to be sorted flowing down along a stable trajectory on the front surface of the chute through the sorting and removal slit, an object to be sorted that should be removed can be reliably hit with ejected air without being affected by turbulence of an air flow or the like, a sorting mistake is less likely to occur, and the accuracy is improved.

Since the rear-side illuminating portion and the ejector nozzle are attached to a single base member, the rear-side illuminating portion and the ejector nozzle can be installed easily at the same time merely by attaching the base member. As a result, manual or robot mass production can be easily performed. In addition, since the device is reduced in size, and the distance between the rear-side illuminating portion and the ejector nozzle, that is, the distance between the optical detection slit and the sorting and removal slit is reduced, the trajectory of mixed grains after passing through the light detection slit and before reaching the sorting and removal slit is less likely to change, and the sorting accuracy increases.

Additionally, since the base member or the rear-side illuminating portion includes a positioning protrusion to be inserted into the optical detection slit to position the base member to the chute, positioning can be easily performed at the time of attachment.

Additionally, since the base member or the ejector nozzle includes a positioning protrusion to be inserted into the sorting and removal slit to position the base member to the chute, positioning can be easily performed at the time of attachment.

Additionally, by storing the front-side illuminating portion, the light receiving part, and the optical path in the front-side housing, assembling is further facilitated, and the front-side illuminating portion, the light receiving part, and the optical path are protected from dust and the like.

Additionally, if the base member serves as the rear-side housing, and the rear-side illuminating portion, the ejector nozzle, and the manifold are stored in the rear-side housing, the device can further be reduced in size, and dust and the like are less likely to adhere to the rear-side illuminating portion.

Additionally, by extending the projecting piece to the outer surface of the rear-side housing, and providing the electromagnetic valve with an engaging stop to be brought into snap engagement with the projecting piece, the electromagnetic valve can be easily attached to the rear-side housing.

Additionally, if the ejector nozzle is coupled to the manifold and the electromagnetic valve installed outside the rear-side housing with an air hose, a manifold and an electromagnetic valve which are commercially available and common can be used.

Additionally, since the rear-side illuminating portion has the light source and the reflector that reflects light radiated from the light source toward the optical detection slit, and the light source, the reflector, and the ejector nozzle are arranged in the order presented from the upstream side of the chute, the distance between the optical detection slit and the sorting and removal slit can be reduced further, and size reduction and increased sorting accuracy can be achieved.

In addition, since dust and the like produced from objects to be sorted flowing down on the front surface of the chute do not enter the rear surface side of the chute without providing the optical detection slit with a translucent plate, dust and the like are less likely to adhere to equipment installed on the rear surface side of the chute. It is possible to prevent dust from adhering particularly to the rear-side optical inspection part, prevent performance from significantly degrading, and prevent a sorting mistake from occurring.

In addition, since the air curtain prevents dust and the like from entering, translucency is not lost as in a device in which dust and the like are blocked by a translucent plate.

Although a device that transmits light through a translucent plate requires the sorting operation to be interrupted when removing dust and the like, the present invention eliminates such a necessity.

Additionally, since the slit air nozzle is arranged such that air of the air curtain is ejected from the upstream side toward the downstream side of the chute, flow-down of the objects to be sorted can be less affected even in a case in which air of the air curtain comes out of the optical detection slit to the front surface side of the chute.

Additionally, since the ejector unit has the ejector nozzle capable of ejecting air to the objects to be sorted on the downstream side of the optical detection slit, the air discharge part is provided on the downstream side of the air curtain ejected from the slit air nozzle, and the surface of the air discharge part opposite to the slit air nozzle is inclined toward the downstream side with distance from the optical detection slit, air of the air curtain efficiently flows toward the air discharge part without flowing out of the optical detection slit to the front surface side of the chute. Thus, air ejection from the ejector nozzle arranged on the downstream side is not affected.

Additionally, since the rear-side optical inspection part includes the rear translucent plate that blocks circulation of air between the slit air nozzle and at least one of the illuminating portion and the light receiving portion that the rear-side optical inspection part has, the rear-side optical inspection part can be protected from dust and the like.

Additionally, since the rear translucent plate air nozzle capable of forming the air curtain that prevents dust and the like from adhering to the rear translucent plate is provided for the rear-side optical inspection part on the slit air nozzle side of the rear translucent plate, dust and the like can be prevented from adhering to the rear translucent plate.

Additionally, the rear-side optical inspection part includes the rear translucent plate that blocks circulation of air between the slit air nozzle and at least one of the illuminating portion and the light receiving portion that the rear-side optical inspection part has, the rear translucent plate air nozzle capable of forming the air curtain that prevents dust and the like from adhering to the rear translucent plate is provided for the rear translucent plate on the slit air nozzle side, the air discharge part is provided on the downstream side of the air curtain ejected from the rear translucent plate air nozzle, and the air discharge part also discharges the air curtain ejected from the slit air nozzle. Thus, the air discharge part can be shared, and a compact configuration can be achieved.

Additionally, the optical inspection unit has the front-side optical inspection part having the illuminating portion that emits light toward the optical detection slit and the light receiving portion that receives at least one of transmitted light and reflected light from the sorting unit of the light emitted from the illuminating portion, at least one of the illuminating portion and the light receiving portion being arranged on the front surface side of the chute, the front-side optical inspection part includes the front translucent plate that blocks circulation of air between the chute and at least one of the illuminating portion and the light receiving portion that the front-side optical inspection part has, and the front translucent plate air nozzle capable of forming the air curtain that prevents dust and the like from adhering to the front translucent plate is provided for the front translucent plate on the chute side. Thus, the front-side optical inspection part can be protected from dust and the like, and dust and the like can be prevented from adhering to the front translucent plate.

Additionally, since the front translucent plate air nozzle is arranged such that the formed air curtain is ejected to be gradually distant from the flowing down direction of the objects to be sorted, flowing down of the objects to be sorted on the chute is not affected.

### BRIEF DESCRIPTION OF DRAWINGS

FIG. 1 is a cross-sectional view of a sorting unit according to a first embodiment of the present invention.

FIG. 2 is a cross-sectional view of an optical sorting device showing the first embodiment of the present invention.

FIG. 3 is a perspective view of a chute according to the first and fourth embodiments of the present invention.

FIG. 4 is a magnified cross-sectional view of an essential part of the optical sorting device showing the first embodiment of the present invention.

FIG. 5 is a magnified cross-sectional view of an essential part of an optical sorting device showing a second embodiment of the present invention.

FIG. 6 is a cross-sectional view of an optical sorting device showing a third embodiment of the present invention.

FIG. 7 is a cross-sectional view of a sorting unit according to a fourth embodiment of the present invention.

FIG. 8 is a cross-sectional view of an optical sorting device showing the fourth embodiment of the present invention.

FIG. 9 is a magnified cross-sectional view of an essential part of the optical sorting device showing the fourth embodiment of the present invention.

FIG. 10 is a cross-sectional view of an optical sorting device showing a fifth embodiment of the present invention.

### DESCRIPTION OF EMBODIMENTS

Hereinafter, embodiments of the present invention will be described with reference to the drawings or the like. Note that the present invention is obviously not limited to the embodiments.

### First Embodiment

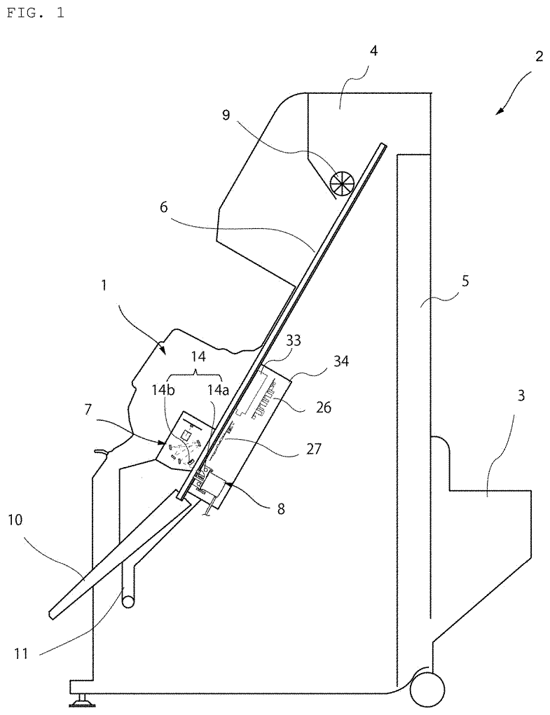

Hereinafter, a first embodiment of the present invention will be described along with FIGS. 1 to 4.

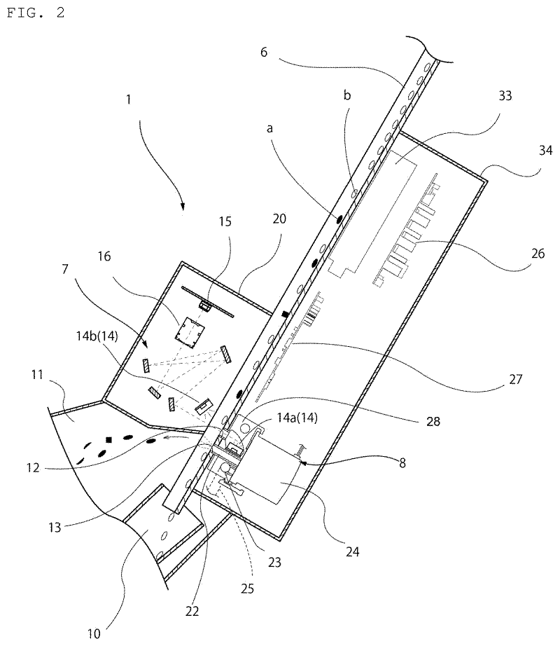

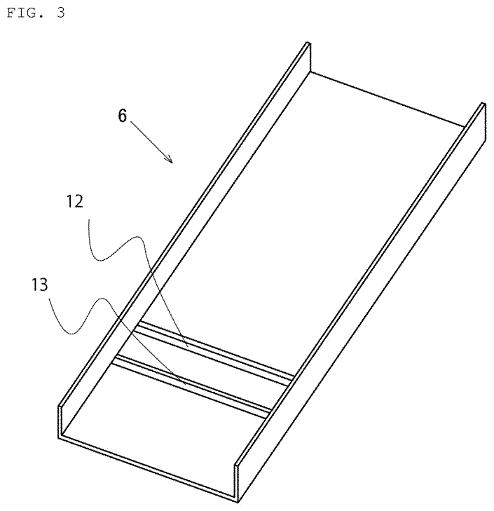

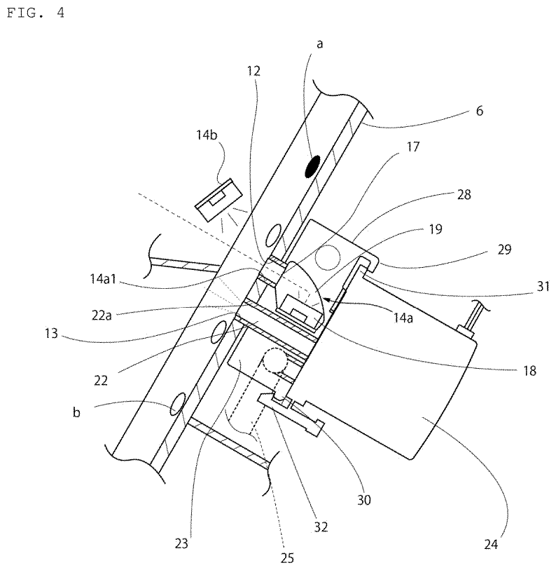

FIG. 1 is a cross-sectional view of a sorting machine in the first embodiment, FIG. 2 is a cross-sectional view of an optical sorting device in the first embodiment, FIG. 3 is a perspective view of a chute in the first embodiment, and FIG. 4 is a magnified cross-sectional view of an essential part of the optical sorting device in the first embodiment.

In the first embodiment, as shown in FIG. 1, an optical sorting device 1 is mounted on a sorting unit 2 of a rice husking and sorting machine not shown. The sorting unit 2 is a secondary sorting unit installed adjacent to a downstream side of a rice husking unit not shown.

In the rice husking unit, unhusked rice is separated into the husk and brown rice, and the husk is primarily sorted. Mixed grains (objects to be sorted) composed of brown rice still containing foreign matters such as husks primarily sorted are sent to the sorting unit 2, and only the foreign matters are sorted and removed from the mixed grains by the optical sorting device 1.

A raw material hopper 3 to which mixed grains are delivered from the rice husking unit is provided at a lower part of the sorting unit 2. A storage tank 4 is installed at an upper part of the optical sorting device 1 above the sorting unit 2. The mixed grains delivered into the raw material hopper 3 are lifted by a grain lifting unit 5 to the storage tank 4.

The mixed grains lifted to the storage tank 4 are supplied to an upper end of a chute 6 via a rotary valve 9. A brown rice discharge channel 10 that discharges brown rice not eliminated by an ejector unit 8 of the optical sorting device 1 is coupled to a lower part of the chute 6. A foreign matter discharge channel 11 that discharges foreign matters eliminated by the ejector unit 8 of the optical sorting device 1 is also coupled to the lower part of the chute 6.

As shown in FIG. 2, the optical sorting device 1 includes the inclined chute 6 on which mixed grains flow down on its front surface. The optical sorting device 1 includes an optical inspection unit 7 arranged opposite to the front surface side and the rear surface side of the chute 6. The optical sorting device 1 includes the ejector unit 8 that, based on an inspection result obtained by the optical inspection unit 7, determines a foreign matter a and a brown rice b among mixed grains, and eliminates only the foreign matter a from the mixed grains.

As shown in FIG. 3, an optical detection slit 12 is formed on the chute 6 in a manner orthogonally crossing the flowing down direction of the mixed grains. A sorting and removal slit 13 is formed on the chute 6 on a downstream side of the optical detection slit 12 in a manner orthogonally crossing the flowing down direction of the mixed grains. The optical detection slit 12 and the sorting and removal slit 13 are formed at close positions.

The widths of the optical detection slit 12 and the sorting and removal slit 13 are set in accordance with the size and weight of the mixed grains flowing down on the chute 6, a removing capability of the ejector unit 8, and the like.

As shown in FIG. 2, the optical inspection unit 7 includes an illuminating part 14 that emits light to mixed grains flowing down on the front surface of the chute 6. The optical inspection unit 7 includes a light receiving part 15 such as a CCD camera that receives transmitted light and reflected light from the mixed grains to which light has been emitted from the illuminating part 14. The optical inspection unit 7 includes an optical path 16 that sends the transmitted light and the reflected light to the light receiving part 15.

The optical path 16 is composed of a plurality of reflective plates and a lens, and the light receiving part 15 and the optical path 16 are stored integrally in a front-side housing 20 together with a front-side illuminating portion 14b.

The front-side housing 20 is arranged on the front surface side of the chute 6 at a position opposite to the optical detection slit 12, and the front-side illuminating portion 14b faces the optical detection slit 12.

Then, light from the front-side illuminating portion 14b is emitted to a grain (the foreign matter a or the brown rice b) passing through the optical detection slit 12, and reflected light from the grain reaches the light receiving part 15 through the optical path 16.

As shown in FIG. 4, the illuminating part 14 includes a rear-side illuminating portion 14a installed on the rear surface side of the chute 6, and the front-side illuminating portion 14b installed on the front surface side of the chute 6.

The rear-side illuminating portion 14a includes a light diffuser plate 17 which is an opaque white translucent plate, a light source 18 such as an LED, and the reflector 19 which is a concave mirror.

The front-side illuminating portion 14b is a light source such as an LED.

The light diffuser plate 17 is provided with its planar direction being in parallel to the flowing down direction on the chute 6.

The light source 18 is provided directly above and in close contact with an ejector nozzle 22, and is arranged so as to radiate light in the direction opposite to the flowing down direction on the chute 6. The light source 18 is in the form of a flat plate, and arranged with its planar direction being in parallel to an ejecting direction in which the ejector nozzle 22 extends.

The reflector 19 reflects light radiated from the light source 18 toward the light diffuser plate 17.

With such an arrangement, the ejector nozzle 22 and the rear-side illuminating portion 14a can be brought close to each other, and the optical detection slit 12 and the sorting and removal slit 13 can be brought close to each other.

The rear-side illuminating portion 14a includes an opening member 14a1 through which light is output to flowing-down mixed grains. The opening member 14a1 forms a positioning protrusion that protrudes from a rear-side housing 28 which is a base member. The light diffuser plate 17 is provided on the light source 18 side of the opening member 14a1.

When the opening member 14a1 which is the positioning protrusion is inserted into the optical detection slit 12, the rear-side housing 28 to which the rear-side illuminating portion 14a has been attached is positioned on the chute 6.

In the present embodiment, the positioning protrusion is the opening member 14a1 of the rear-side illuminating portion 14a, but a similar component may be provided on the portion of the rear-side housing 28 to which the rear-side illuminating portion 14a is to be attached to configure a positioning protrusion on the base member.

The ejector unit 8 includes a plurality of ejector nozzles 22, a manifold 23 that distributes high-pressure air to the ejector nozzles 22, and an electromagnetic valve 24 that controls air ejection from the ejector nozzles 22.

An air supply pipe 25 is connected to the manifold 23, and high-pressure air is supplied from a compressor or the like to the manifold 23 through the air supply pipe 25.

In addition, the electromagnetic valve 24 is connected to the light receiving part 15 of the optical inspection unit 7 with a valve driving circuit substrate 26 and a signal processing substrate 27 interposed therebetween (FIG. 2).

A leading end 22a of the ejector nozzle 22 forms the positioning protrusion that protrudes from the rear-side housing 28 which is the base member.

When the leading end 22a of the ejector nozzle 22 which is the positioning protrusion is inserted into the sorting and removal slit 13, the rear-side housing 28 to which the ejector unit 8 has been attached is positioned on the chute 6.

In the present embodiment, the positioning protrusion is the leading end 22a of the ejector nozzle 22, but a similar component may be provided on the portion of the rear-side housing 28 to which the ejector nozzle 22 is to be attached to configure a positioning protrusion on the base member.

The box-like rear-side housing 28 is attached as the base member to the rear surface side of the chute 6. The rear-side illuminating portion 14a, the ejector nozzles 22, and the manifold 23 are integrally stored in the rear-side housing 28. In other words, the rear-side illuminating portion 14a, the ejector nozzles 22, and the manifold 23 can be unitized by the rear-side housing 28 which is the base member.

A front surface of the rear-side housing 28 opposite to the rear surface of the chute 6 is open so as to allow the opening member 14a1 of the rear-side illuminating portion 14a and the leading end 22a of the ejector nozzle 22 which serve as the positioning protrusions to protrude.

The back surface of the rear-side housing 28 is provided with openings for the manifold 23 and the electromagnetic valve 24 to communicate with each other and the ejector nozzle 22 and the electromagnetic valve 24 to communicate with each other.

A hook part 29 is formed at one end of the back surface of the rear-side housing 28, and a projecting piece 30 is extended at the other end of the back surface.

A flange 31 is formed at one end of the front surface of the electromagnetic valve 24, and a locking stop 32 to be brought into snap engagement with the projecting piece 30 is provided on the other end of the front surface.

The electromagnetic valve 24 is inclined to insert the flange 31 into the hook part 29, and then the electromagnetic valve 24 is turned to bring the locking stop 32 into snap engagement with the projecting piece 30. The electromagnetic valve 24 can thereby be attached to the back surface (outer surface) of the rear-side housing 28 with a single touch to be fitted over the manifold 23.

At replacement or the like of the electromagnetic valve 24, the electromagnetic valve 24 can be easily detached from the rear-side housing 28 by pivoting the locking stop 32 to be moved away from the projecting piece 30.

Assembling on the rear side of the chute 6 is performed in the following manner.

The rear-side illuminating portion 14a, the ejector nozzles 22, and the manifold 23 are stored in the rear-side housing 28 to be unitized. The opening member 14a1 of the rear-side illuminating portion 14a and the leading end 22a of the ejector nozzle 22 which serve as the positioning protrusions protrude from the front surface of the rear-side housing 28.

The opening member 14a1 of the rear-side illuminating portion 14a and the leading end 22a of the ejector nozzle 22 which serve as the positioning protrusions are respectively inserted into the optical detection slit 12 and the sorting and removal slit 13 to be positioned, so that the rear-side housing 28 is attached to the rear surface of the chute 6.

The rear-side housing 28 is installed such that the opening member 14a1 of the rear-side illuminating portion 14a faces the optical detection slit 12, and the leading end 22a of the ejector nozzle 22 faces the sorting and removal slit 13.

The rear-side housing 28 is further fixed by engaging the stop with the rear surface of the chute 6 or by means of a fixture such as a screw.

The electromagnetic valve 24 is attached to the back surface of the rear-side housing 28 at appropriate timing.

The rear-side housing 28, the valve driving circuit substrate 26, the signal processing substrate 27, and a power source 33 that drives the optical sorting device 1 are stored in a box 34, and the box 34 is installed on the rear surface side of the chute 6 (FIGS. 1 and 2).

Light from the rear-side illuminating portion 14a is emitted to a grain passing above the optical detection slit 12 through the optical detection slit 12, and light transmitted through the grain reaches the light receiving part 15 through the optical path 16.

Light from the front-side illuminating portion 14b is emitted to the grain passing above the optical detection slit 12, and light reflected by the grain reaches the light receiving part 15 through the optical path 16.

A light reception signal of the light receiving part 15 is sent to the signal processing substrate 27. A signal level of the light reception signal is compared with a threshold value in the signal processing substrate 27, and it is determined whether the grain is the foreign matter a or the brown rice b.

A determination result obtained by the signal processing substrate 27 is transmitted to the valve driving circuit substrate 26. Opening/closing of the electromagnetic valve 24 is controlled by the valve driving circuit substrate 26.

In a case in which the grain is determined as the foreign matter a, high-pressure air is ejected from one of the ejector nozzles 22 selected by opening/closing control of the electromagnetic valve 24 when the grain passes through the sorting and removal slit 13. The foreign matter a is eliminated from the front surface of the chute 6 with the high-pressure air ejected from the ejector nozzle 22. The eliminated foreign matter a is discharged to the foreign matter discharge channel 11.

The brown rice b not having been eliminated is sent to the next step through the brown rice discharge channel 10.

### Second Embodiment

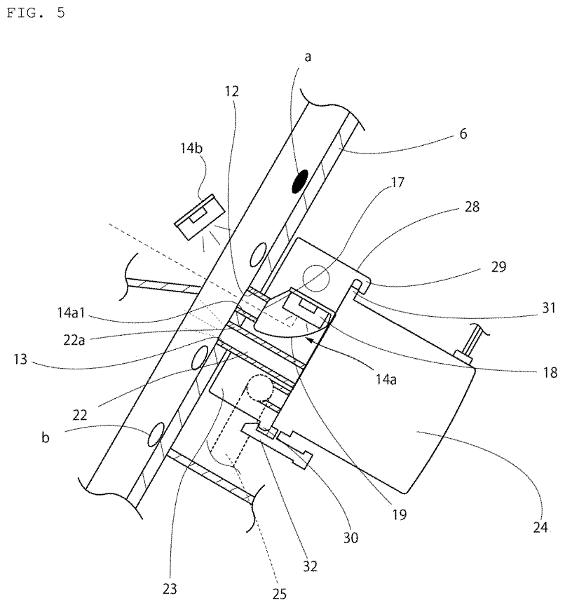

Hereinafter, a second embodiment according to the present invention will be described along with FIG. 5. Note that description of points similar to those of the first embodiment will be omitted, and different points will mainly be described.

In the second embodiment, the light source 18 of the rear-side illuminating portion 14a is installed oppositely so as to radiate light toward the ejector nozzles 22.

The reflector 19 is provided directly above and in close contact with the ejector nozzles 22.

Light radiated from the light source 18 is reflected by the reflector 19 toward the light diffuser plate 17, and emitted to mixed grains through the optical detection slit 12. In other words, the light source 18, the reflector 19, and the ejector nozzles 22 are arranged in an order presented from the upstream side of the chute 6 in the flowing down direction on the chute 6.

The reflector 19 that can have a smaller space (height in the flowing down direction on the chute 6) than the light source 18 is brought into close contact with the ejector nozzles 22 to arrange the light source 18 on the upstream side of the reflector 19 in the flowing down direction on the chute 6. The opening member 14a1 of the rear-side illuminating portion 14a can thereby be brought closer to the ejector nozzles 22, so that the distance between the optical detection slit 12 and the sorting and removal slit 13 can be reduced further. Thus, sorting accuracy can be improved.

### Third Embodiment

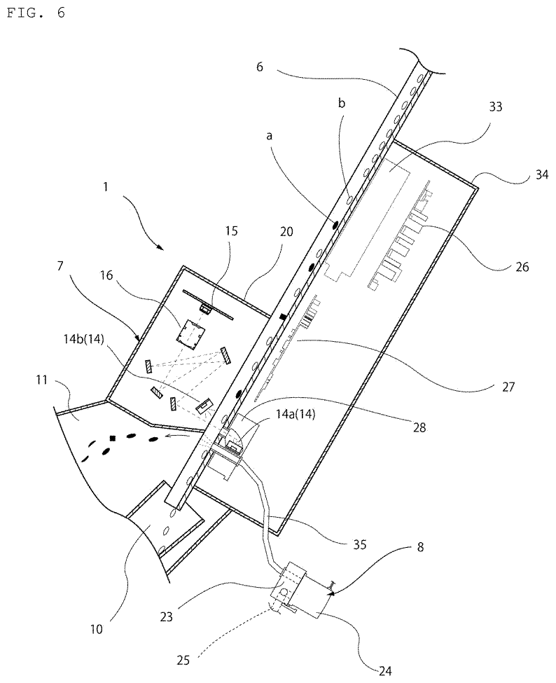

Hereinafter, a third embodiment according to the present invention will be described along with FIG. 6. Note that description of points similar to those of the first embodiment or the second embodiment will be omitted, and different points will mainly be described.

In the third embodiment, the rear-side illuminating portion 14a and the ejector nozzles 22 are installed in the rear-side housing 28, and the manifold 23 and the electromagnetic valve 24 are installed outside the rear-side housing 28. Specifically, the manifold 23 and the electromagnetic valve 24 are provided outside the box 34.

The electromagnetic valve 24 is fitted over the manifold 23, and coupled to the ejector nozzles 22 with an air hose 35.

It is not necessary to provide the rear-side housing 28 with a hook part, a projecting piece, or the like for attaching the electromagnetic valve 24.

### Fourth Embodiment

Hereinafter, a fourth embodiment of the present invention will be described along with FIGS. 3, and 7 to 9.

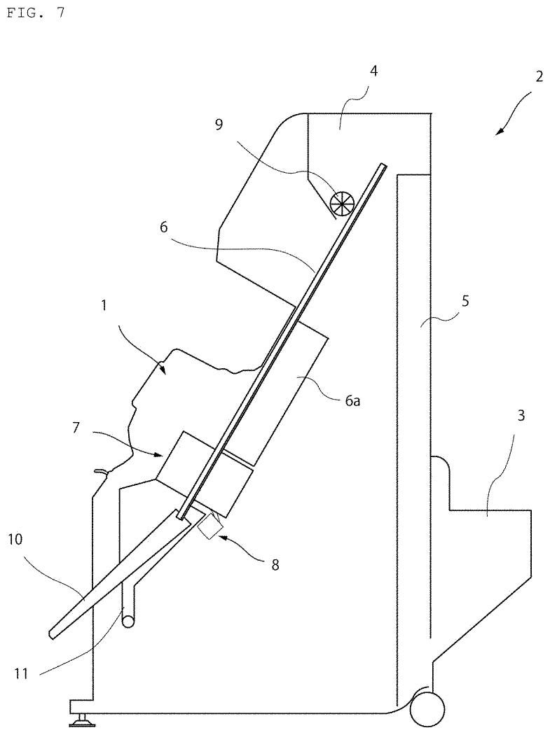

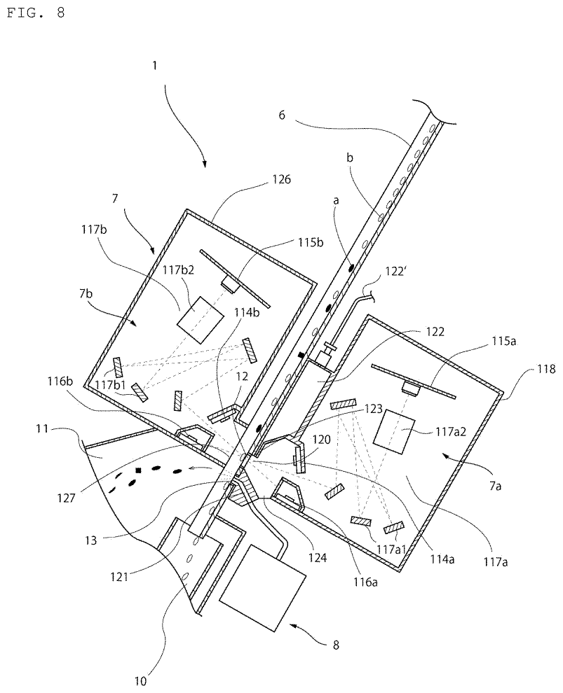

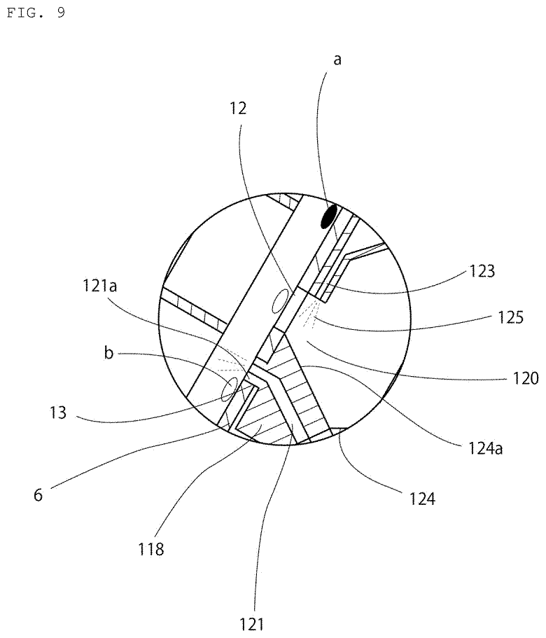

FIG. 7 is a cross-sectional view of a sorting machine in the fourth embodiment, FIG. 3 is a perspective view of a chute in the fourth embodiment, FIG. 8 is a cross-sectional view of an optical sorting device in the fourth embodiment, and FIG. 9 is a magnified cross-sectional view of an essential part of the optical sorting device in the fourth embodiment.

In the fourth embodiment, as shown in FIG. 7, the optical sorting device 1 is mounted on a sorting unit of a rice husking and sorting machine not shown. The sorting unit 2 is a secondary sorting unit installed adjacent to the downstream side of a rice husking unit not shown.

Unhusked rice is separated into the husk and brown rice in the rice husking unit, and the husk is primarily sorted. Mixed grains (objects to be sorted) composed of brown rice still containing foreign matters such as husks primarily sorted are sent to the sorting unit 2, and only the foreign matters are sorted and removed from the mixed grains by the optical sorting device 1.

A raw material hopper 3 to which mixed grains are delivered from the rice husking unit is provided at a lower part of the sorting unit 2. A storage tank 4 is installed at an upper part of the optical sorting device 1 above the sorting unit 2. The mixed grains delivered into the raw material hopper 3 are lifted by the grain lifting unit 5 to the storage tank 4.

The mixed grains lifted to the storage tank 4 are supplied to an upper end of a chute 6 via a rotary valve 9. A brown rice discharge channel 10 that discharges brown rice not eliminated by an ejector unit 8 of the optical sorting device 1 is coupled to the lower part of the chute 6. A foreign matter discharge channel 11 that discharges foreign matters eliminated by the ejector unit 8 of the optical sorting device 1 is also coupled to the lower part of the chute 6.

The optical sorting device 1 includes the inclined chute 6 on which mixed grains flow down on its front surface. The optical sorting device 1 includes an optical inspection unit 7 that performs optical inspection to the mixed grains flowing down on the front surface of the chute 6. The optical sorting device 1 includes the ejector unit 8 that, based on an inspection result obtained by the optical inspection unit 7, determines a foreign matter a and a brown rice b among mixed grains, and eliminates only the foreign matter a from the mixed grains.

A box 6a that stores a signal processing substrate, an electromagnetic valve driving circuit substrate, a power source, and the like, neither shown, is attached to the rear surface of the chute 6.

As shown in FIG. 3, the optical detection slit 12 is formed on the chute 6 in a manner orthogonally crossing the flowing down direction of the mixed grains. The sorting and removal slit 13 is formed on the chute 6 on the downstream side of the optical detection slit 12 in the manner orthogonally crossing the flowing down direction of the mixed grains. The optical detection slit 12 and the sorting and removal slit 13 are formed at close positions.

The widths of the optical detection slit 12 and the sorting and removal slit 13 are set in accordance with the size and weight of the mixed grains flowing down on the chute 6, a removing capability of the ejector unit 8, and the like.

As shown in FIG. 8, the optical inspection unit 7 includes a rear-side optical inspection part 7a and a front-side optical inspection part 7b installed on the rear surface side and the front surface side of the chute 6 at positions with the optical detection slit 12 interposed therebetween.

The rear-side optical inspection part 7a includes a rear-side illuminating portion 114a such as an LED, a rear-side light receiving portion 115a such as a CCD camera, a rear-side background illuminating portion 116a to be opposite to the front-side optical inspection part 7b, and a rear-side optical path 117a having a plurality of reflective plates 117a1 and a lens 117a2, and is stored in a rear-side housing 118.

As shown in FIGS. 8 and 9, a rear-side opening 120 through which light passes is formed in the rear-side housing 118. The rear-side housing 118 is attached to the rear surface side of the chute 6 in a manner that the rear-side opening 120 conforms to the optical detection slit 12.

The rear-side opening 120 is formed across the entire widthwise length of the optical detection slit 12, and light radiated from the rear-side illuminating portion 114a is emitted to a grain passing above the optical detection slit 12 (the foreign matter a or the brown rice b) through the rear-side opening 120 and the optical detection slit 12.

As shown in FIG. 9, an ejector nozzle 121 of the ejector unit 8 is incorporated in the rear-side housing 118. A leading end 121a of the ejector nozzle 121 is exposed at the outer surface of the rear-side housing 118 on a downstream side of the rear-side opening 120 on the chute 6 to face the sorting and removal slit 13. Specifically, the leading end 121a of the ejector nozzle 121 protrudes from the surface of the rear-side housing 118 on the rear surface side of the chute 6 to form a positioning protrusion.

When the leading end 121a of the ejector nozzle 121 which serves as the positioning protrusion is inserted into the sorting and removal slit 13, the rear-side housing 118 to which the ejector unit 8 has been attached is positioned on the chute 6.

As shown in FIGS. 8 and 9, an air chamber 122 to which air is supplied via an air supply pipe 122′ is formed in the rear-side housing 118 on the upstream side of the rear-side opening 120 on the chute 6. A slit air nozzle 123 that ejects air from the air chamber 122 toward the rear-side opening 120 is disposed. An air curtain 125 can be formed by air ejected from this slit air nozzle 123.

The air discharge part 124 is formed so as to open to the outside of the rear-side housing 118 on the downstream side with the interposition of the rear-side opening 120 of the rear-side housing 118 and on the downstream side of the air curtain 125 ejected from the slit air nozzle 123.

The effective air curtain 125 is formed by air ejected from the slit air nozzle 123 and discharged from the air discharge part 124. This can prevent dust and the like from entering the rear-side optical inspection part 7a through the optical detection slit 12.

Air of the air curtain 125 is arranged so as to be ejected from the upstream side toward the downstream side of the chute 6 on the rear surface side of the optical detection slit 12. Accordingly, even in a case in which air of the air curtain 125 comes out to the front surface side of the chute 6 from the optical detection slit 12, an influence upon flow-down of mixed grains can be reduced.

As shown in FIG. 9, a surface 124a of the air discharge part 124 opposite to the slit air nozzle 123 is inclined to the downstream side with distance from the optical detection slit 12. The air curtain 125 ejected from the slit air nozzle 123 thereby hits the opposite surface to be efficiently guided to a discharge port of the air discharge part 124. Thus, air of the air curtain 125 flows toward the discharge port of the air discharge part 124 without flowing out to the front surface side of the chute 6 through the optical detection slit 12. Therefore, air ejection from the ejector nozzle 121 arranged on the downstream side is not affected.

The rear-side housing 118 is further fixed by engaging the stop with the rear surface of the chute 6 or by means of a fixture such as a screw.

As shown in FIG. 8, the front-side optical inspection part 7b includes a front-side illuminating portion 114b such as an LED, a front-side light receiving portion 115b such as a CCD camera, a front-side background illuminating portion 116b to be opposite to the rear-side optical inspection part 7a, and a front-side optical path 117b having a plurality of reflective plates 117b1 and a lens 117b2, and is stored in a front-side housing 126.

A front-side opening 127 through which light passes is formed in the front-side housing 126. The front-side housing 126 is installed on the front surface side of the chute 6 in a manner that the front-side opening 127 conforms to the optical detection slit 12.

The front-side opening 127 is formed across the entire widthwise length of the chute 6, and light radiated from the front-side illuminating portion 114b is emitted to a grain (the foreign matter a or the brown rice b) passing above the optical detection slit 12 through the front-side opening 127.

Light from the rear-side illuminating portion 114a is emitted from the rear surface side to the grain passing above the optical detection slit 12 through the rear-side opening 120 and the optical detection slit 12 of the rear-side housing 118. Light from the front-side illuminating portion 114b is emitted from the front surface side to the grain passing above the optical detection slit 12 through the front-side opening 127 of the front-side housing 126.

Light reflected by the grain and light transmitted through the grain advance into the rear-side housing 118 and the front-side housing 126 through the rear-side opening 120 and the front-side opening 127, and are received by the rear-side light receiving portion 115a and the front-side light receiving portion 115b via the rear-side optical path 117a and the front-side optical path 117b.

Light reception signals received by the rear-side light receiving portion 115a and the front-side light receiving portion 115b are sent to a signal processing substrate not shown but stored in the box 6a. A signal level of the light reception signals is compared with a threshold value in the signal processing substrate, and it is determined whether the grain is the foreign matter a or the brown rice b.

A determination result obtained by the signal processing substrate is transmitted to a valve driving circuit substrate not shown but stored in the box 6a. Opening/closing of an electromagnetic valve not shown of the ejector unit 8 is controlled by the valve driving circuit substrate.

In a case in which the grain is determined as the foreign matter a, high-pressure air is ejected from the ejector nozzle 121 selected by opening/closing control of electromagnetic valve when the grain passes through the sorting and removal slit 13. The foreign matter a is eliminated from the front surface of the chute 6 with the high-pressure air ejected from the ejector nozzle 121. The eliminated foreign matter a is discharged through the foreign matter discharge channel 11.

A grain which is the brown rice b not having been eliminated is sent to the next step through the brown rice discharge channel 10.

Since the optical detection slit 12 is blocked by the air curtain 125, dust and the like produced from mixed grains flowing down on the front surface of the chute 6 neither enter the rear surface side of the chute 6 nor adhere to the rear-side optical inspection part 7a in the rear-side housing 118 through the rear-side opening 120.

### Fifth Embodiment

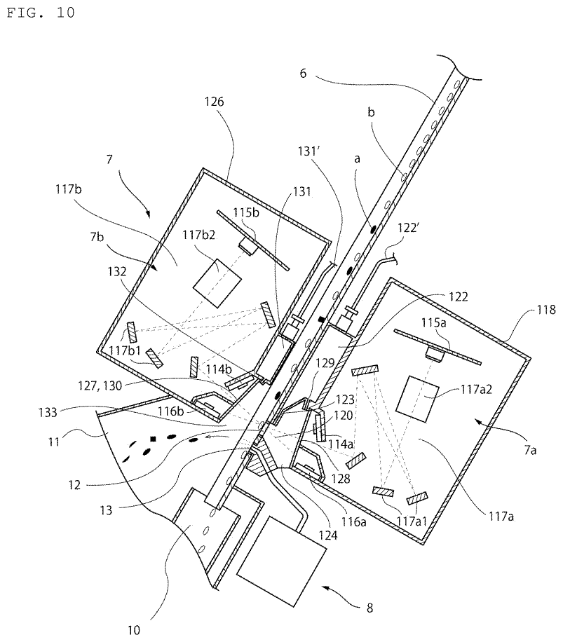

Hereinafter, a fifth embodiment according to the present invention will be described along with FIG. 10. Note that description of points similar to those of the fourth embodiment will be omitted, and different points will mainly be described.

In the fifth embodiment, the rear-side optical inspection part 7a includes a rear translucent plate 128 that blocks circulation of air between the slit air nozzle 123 and the rear-side illuminating portion 114a, the rear-side background illuminating portion 116a, the rear-side optical path 117a, and the rear-side light receiving portion 115a.

Specifically, in the rear-side housing 118, the rear translucent plate 128 is fitted on the farther side of the rear-side opening 120 so as to cross the internal space. The rear-side opening 120 and the rear-side illuminating portion 114a, the rear-side background illuminating portion 116a, the rear-side optical path 117a, and the rear-side light receiving portion 115a of the rear-side optical inspection part 7a are blocked by the rear translucent plate 128.

Accordingly, the rear-side optical inspection part 7a is strictly protected even if dust and the like fly due to the air curtain 125.

A rear translucent plate air nozzle 129 is provided on the slit air nozzle 123 side on the chute 6 side of the rear translucent plate 128 and on the upstream side. The rear translucent plate air nozzle 129 is provided to communicate with the air chamber 122. The rear translucent plate air nozzle 129 is arranged so as to eject air along the rear translucent plate 128, and this air allows the air curtain to be formed along the rear translucent plate 128.

Therefore, dust and the like can be prevented from adhering to the rear translucent plate 128.

This air curtain is discharged through the opening of the air discharge part 124. In other words, this air discharge part 124 can discharge both the air curtain ejected from the rear translucent plate air nozzle 129 and the air curtain 125 ejected from the slit air nozzle 123.

Therefore, the air discharge part can be used in common, and a compact configuration can be achieved.

The front-side optical inspection part 7b includes a front translucent plate 130 that blocks circulation of air between the chute 6 and the front-side illuminating portion 114b, the front-side background illuminating portion 116b, the front-side optical path 117b, and the front-side light receiving portion 115b.

Specifically, the front translucent plate 130 is fitted in the front-side opening 127 of the front-side housing 126. The front surface side of the chute 6 and the front-side illuminating portion 114b, the front-side background illuminating portion 116b, the front-side optical path 117b, and the front-side light receiving portion 115b are blocked by the front translucent plate 130.

Dust and the like produced on the front surface side of the chute 6 are thereby prevented from entering the inside of the front-side housing 126, and the front-side optical inspection part 7b is strictly protected.

A front translucent plate air nozzle 132 is provided on the chute 6 side of the front translucent plate 130 and on the upstream side. The front translucent plate air nozzle 132 is provided to communicate with an air chamber 131. An air supply pipe 131′ is coupled to the air chamber 131. The front translucent plate air nozzle 132 is arranged so as to eject air along the front translucent plate 130, and this air allows an air curtain to be formed along the front translucent plate 130.

Therefore, dust and the like can be prevented from adhering to the front translucent plate 130.

The direction in which the air curtain formed by the front translucent plate 130 and the front translucent plate air nozzle 132 is formed is provided so as to be gradually depart from the flowing down direction of mixed grains flowing down on the chute 6. In other words, a space 133 between the front translucent plate 130 and the chute 6 is formed so as to be wider toward the downstream. Thus, the air curtain formed by the front translucent plate air nozzle 132 does not affect flowing down of mixed grains on the chute.

In addition, a lower part of the space 133 forms an air discharge part for the air curtain formed by the front translucent plate air nozzle 132.

[Modifications]

The present invention is not limited to the above-described embodiments. For example, the following are also included.

In the present embodiment, the optical sorting device sorts foreign matters such as husks and brown rice, but can also be used for sorting other cereals, beans, resin pellets, or the like.

In the present embodiment, the rear-side illuminating portion does not include an optical path or a light receiving portion, but this is not a limitation. The rear-side illuminating portion may include an optical path and a light receiving portion.

In the present embodiment, the base member is the box-like rear-side housing, but may be a member having a plate-like shape on which the rear-side illuminating portion and the ejector nozzle can be placed for unitization, rather than storing components inside.

In the first and second embodiments, the projecting piece and the engaging stop are provided only at one-side ends of the rear-side housing and the electromagnetic valve, but, a projecting piece and an engaging stop to be brought into snap engagement with the projecting piece may be provided on each side end. In addition, the rear-side housing and the electromagnetic valve can also be joined with another locking instrument.

In the present embodiment, the positioning protrusions are provided so as to be inserted into both the optical detection slit 12 and the sorting and removal slit 13, but this is not a limitation. A positioning protrusion may be provided so as to be inserted into either one of them.

The present embodiment is configured such that the positioning protrusions are inserted into the optical detection slit 12 and the sorting and removal slit 13 when positioning the base member on the chute, but this is not a limitation. For example, the rear-side housing 28 is attached to a place other than the slits on the rear surface of the chute 6 by hooking a stop or by means of a fixture such as a screw, but may be automatically aligned in position by aligning a stop-engaging position or a hole through which the fixture insertion is to be inserted.

In the present embodiment, the optical sorting device sorts foreign matters such as husks and brown rice, but can also be used for sorting other cereals, beans, resin pellets, or the like.

In the present embodiment, both the front-side optical inspection part and the rear-side optical inspection part include light source, optical paths, and light receiving portions, but this is not a limitation. For example, one of them may include a light source portion, and the other may include a light receiving portion alone.

In the present embodiment, air is ejected from the ejector nozzle installed on the rear surface side of the chute to the front surface side of the chute through the sorting and removal slit, but, air may be ejected to objects to be sorted released from the lower end of the chute without providing the sorting and removal slit. In this case, air may be ejected from the upper side toward the lower side.

In the present embodiment, the rear-side optical inspection part and the ejector nozzle are stored in the rear-side housing, and the front-side optical inspection part is stored in the front-side housing, but, the components stored in the rear-side housing and the front-side housing may be installed individually without providing the rear-side housing or the front-side housing. In this case, the slit air nozzle that forms the air curtain that blocks the light detection slit is provided for the chute.

In the present embodiment, the positioning protrusion is provided so as to be inserted into the sorting and removal slit, but this is not a limitation, and may be provided for the rear-side housing to be inserted into the optical detection slit, or may be provided to be inserted into both.

The present embodiment is configured such that the positioning protrusion is inserted into the sorting and removal slit when positioning the rear-side housing on the chute, but this is not a limitation. For example, the rear-side housing is attached to a place other than the slits on the rear surface of the chute 6 by hooking a stop or by means of a fixture such as a screw, but may be automatically aligned in position by aligning a stop-engaging position or a hole through which the fixture insertion is to be inserted.

Each technical matter in any of the embodiments may be applied to another embodiment to obtain an example.

### REFERENCE SIGNS LIST

1 optical sorting device

2 sorting unit

3 raw material hopper

4 storage tank

5 grain lifting unit

6 chute

7 optical inspection unit

7a rear-side optical inspection part

7b front-side optical inspection part

8 ejector unit

9 rotary valve

10 brown rice discharge channel

11 foreign matter discharge channel

12 optical detection slit

13 sorting and removal slit

14 illuminating part

14a rear-side illuminating portion

14b front-side illuminating portion

15 light receiving part

16 optical path

17 light diffuser plate

18 light source

19 reflector

20 front-side housing

22 ejector nozzle

23 manifold

24 electromagnetic valve

25 air supply pipe

26 valve driving circuit substrate

27 signal processing substrate

28 rear-side housing

29 hook part

30 projecting piece

31 flange

32 locking stop

33 power source

34 box

35 air hose

114a rear-side illuminating portion

114b front-side illuminating portion

115a rear-side light receiving portion

115b front-side light receiving portion

116a rear-side background illuminating portion

116b front-side background illuminating portion

117a rear-side optical path

117b front-side optical path

118 rear-side housing

120 rear-side opening

121 ejector nozzle

122 air chamber

122′ air supply pipe

123 slit air nozzle

124 air discharge part

125 air curtain

126 front-side housing

127 front-side opening

128 rear translucent plate

129 rear translucent plate air nozzle

130 front translucent plate

131 air chamber

131′ air supply pipe

132 front translucent plate air nozzle

133 space

1. An optical sorting device comprising:
a chute having an optical detection slit and a sorting and removal slit arranged on a downstream side of the optical detection slit, an object to be sorted flowing down on a front surface of the chute;
an optical inspection unit having an illuminating part having a rear-side illuminating portion installed on a rear surface side of the chute and configured to emit light to the object to be sorted through an opening, a light receiving part configured to receive at least one of transmitted light and reflected light from the object to be sorted of the light emitted from the illuminating part, and an optical path configured to send at least one of the transmitted light and the reflected light to the light receiving part, the optical inspection unit being configured to inspect the object to be sorted flowing down on the front surface of the chute; and
an ejector unit having an ejector nozzle capable of ejecting air to the object to be sorted flowing down on the front surface of the chute, and configured to sort and remove the object to be sorted based on an inspection result obtained by the optical inspection unit,
the optical sorting device comprising:
a base member attached to the rear surface side of the chute, wherein
at least the rear-side illuminating portion and the ejector nozzle are attached to the base member, and the base member is installed such that the opening of the rear-side illuminating portion faces the optical detection slit, and a leading end of the ejector nozzle faces the sorting and removal slit.

2. The optical sorting device according to claim 1, wherein the base member or the rear-side illuminating portion includes a positioning protrusion to be inserted into the optical detection slit to position the base member on the chute.

3. The optical sorting device according to claim 1, wherein the base member or the ejector nozzle includes a positioning protrusion to be inserted into the sorting and removal slit to position the base member on the chute.

4. The optical sorting device according to claim 1, wherein
the base member is a rear-side housing,
the ejector unit has the ejector nozzle, a manifold configured to distribute high-pressure air to the ejector nozzle, and an electromagnetic valve configured to control distribution of the manifold based on the inspection result obtained by the optical inspection unit, and
the rear-side illuminating portion, the ejector nozzle, and the manifold are stored in the rear-side housing, and the electromagnetic valve is attached to an outer surface of the rear-side housing.

5. The optical sorting device according to claim 4, wherein
a projecting piece is extended at the outer surface of the rear-side housing,
the electromagnetic valve is provided with an engaging stop, and
the engaging stop is brought into snap engagement with the projecting piece to attach the electromagnetic valve to the outer surface of the rear-side housing.

6. The optical sorting device according to claim 1, wherein
the base member is a rear-side housing,
the ejector unit has the ejector nozzle, a manifold configured to distribute high-pressure air to the ejector nozzle, and an electromagnetic valve configured to control distribution of the manifold based on the inspection result obtained by the optical inspection unit, and
the rear-side illuminating portion and the ejector nozzle are stored in the rear-side housing, and the ejector nozzle is coupled to the manifold and the electromagnetic valve installed outside the rear-side housing with an air hose.

7. The optical sorting device according to claim 1, wherein
the rear-side illuminating portion has a light source, and a reflector configured to reflect light radiated from the light source toward the optical detection slit, and
the light source, the reflector, and the ejector nozzle are arranged in an order presented from an upstream side of the chute.

8. The optical sorting device according to claim 1, comprising:
a front-side housing on a front surface side of the chute, wherein
the illuminating part has a front-side illuminating portion installed on the front surface side of the chute, and
at least the front-side illuminating portion, the light receiving part, and the optical path are stored in the front-side housing.

9. A rice husking and sorting machine comprising the optical sorting device according to claim 1.

10. An optical sorting device comprising:
a chute having an optical detection slit, an object to be sorted flowing down on a front surface of the chute;
an optical inspection unit having a rear-side optical inspection part having an illuminating portion configured to emit light toward the optical detection slit and a light receiving portion configured to receive at least one of transmitted light and reflected light of the light emitted from the illuminating portion, at least one of the illuminating portion and the light receiving portion being arranged on a rear surface side of the chute, the optical inspection unit being configured to inspect the object to be sorted flowing down on the front surface of the chute; and
an ejector unit configured to sort and remove the object to be sorted based on an inspection result obtained by the optical inspection unit, wherein
a slit air nozzle capable of forming an air curtain configured to prevent dust and the like from entering the rear-side optical inspection part through the optical detection slit is provided on the rear surface side of the chute.

11. The optical sorting device according to claim 10, wherein the slit air nozzle is arranged such that air of the air curtain is ejected from an upstream side to a downstream side of the chute.

12. The optical sorting device according to claim 11, wherein
the ejector unit has an ejector nozzle capable of ejecting air to the object to be sorted on a downstream side of the optical detection slit,
an air discharge part is provided on a downstream side of the air curtain ejected from the slit air nozzle, and
a surface of the air discharge part opposite to the slit air nozzle is inclined to the downstream side with distance from the optical detection slit.

13. The optical sorting device according to claim 10, wherein the rear-side optical inspection part includes a rear translucent plate configured to block circulation of air between the slit air nozzle and at least one of the illuminating portion and the light receiving portion that the rear-side optical inspection part has.

14. The optical sorting device according to claim 13, wherein a rear translucent plate air nozzle capable of forming an air curtain configured to prevent dust and the like from adhering to the rear translucent plate is provided on a side of the slit air nozzle of the rear translucent plate.

15. The optical sorting device according to claim 12, wherein
the rear-side optical inspection part includes a rear translucent plate configured to block circulation of air between the slit air nozzle and at least one of the illuminating portion and the light receiving portion that the rear-side optical inspection part has,
a rear translucent plate air nozzle capable of forming an air curtain configured to prevent dust and the like from adhering to the rear translucent plate is provided on a side of the slit air nozzle of the rear translucent plate,
an air discharge part is provided on a downstream side of the air curtain ejected from the rear translucent plate air nozzle, and
the air discharge part also discharges the air curtain ejected from the slit air nozzle.

16. The optical sorting device according to claim 10, wherein
the optical inspection unit has a front-side optical inspection part having an illuminating portion configured to emit light toward the optical detection slit and a light receiving portion configured to receive at least one of transmitted light and reflected light of the light emitted from the illuminating portion, at least one of the illuminating portion and the light receiving portion being arranged on a front surface side of the chute,
the front-side optical inspection part includes a front translucent plate configured to block circulation of air between the chute and at least one of the illuminating portion and the light receiving portion that the front-side optical inspection part has, and
a front translucent plate air nozzle capable of forming an air curtain configured to prevent dust and the like from adhering to the front translucent plate is provided for the front translucent plate on a side of the chute.

17. The optical sorting device according to claim 16, wherein the front translucent plate air nozzle is arranged such that the air curtain formed is ejected so as to be gradually depart from the flowing down direction of the object to be sorted.

18. A rice husking and sorting machine comprising the optical sorting device according to claim 10.
